(19) United States
(12) Patent Application Publication
(10) Pub. No.: US 2026/0226637 A1
(43) Pub. Date: Aug. 6, 2026

(54) DUAL H2 PRODUCTION FROM ELECTROCATALYTIC WATER REDUCTION COUPLED WITH FORMALDEHYDE OXIDATION VIA A COPPER-SILVER ELECTROCATALYST

(71) Applicant: University of Cincinnati, Cincinnati, OH (US)

(72) Inventor: Yujie Sun, Mason, OH (US)

(73) Assignee: University of Cincinnati, Cincinnati, OH (US)

(21) Appl. No.: 19/148,608

(22) PCT Filed: Jan. 19, 2024
(86) PCT No.: PCT/US2024/012168

§ 371 Date: Jul. 16, 2025

Related U.S. Application Data
(60) Provisional application No. 63/440,048, filed on Jan. 19, 2023.

(51) Int. Cl. C25B 11/089; C25B 1/04; C25B 9/19; C25B 11/052; C25B 11/061; C25B 11/065

(52) U.S. Cl. CPC C25B 11/089; C25B 1/04; C25B 9/19; C25B 11/052; C25B 11/061; C25B 11/065

(57) ABSTRACT

The present disclosure concerns an electrocatalytic system and methods of the use thereof for the generation of hydrogen at both electrodes. In aspects, the present disclosure concerns an anode of a copper-silver bimetallic alloy, Cu₃Ag₇, and a basic anolyte with an aldehyde therein. The aldehyde reacts with the hydroxyl groups from the catholyte to produce hydrogen and the catholyte reacts water therein with the electrons from the anolyte to also produce hydrogen in a highly Faradaic efficient system. Application of the present disclosure not only provides for production of clean hydrogen, but also offers an approach for aldehyde decontamination.

### CROSS REFERENCE TO RELATED APPLICATION

This application claims priority to U.S. Provisional Application Ser. No. 63/440,048, filed Jan. 19, 2023, the entire contents of which are incorporated herein by reference.

### STATEMENT REGARDING FEDERALLY SPONSORED RESEARCH OR DEVELOPMENT

This invention was made with government support under CHE-1914546 and CHE-2102220 awarded by the National Science Foundation. The government has certain rights in the invention.

### TECHNICAL FIELD

The present disclosure concerns electrocatalytic cell systems and products derived therefrom.

### BACKGROUND

Hydrogen (H₂) is not only an important feedstock in the chemical industry (e.g., petroleum refining, ammonia production from the Haber-Bosch process) but it also plays an important role in the future energy economy, because H₂ is a carbon-zero energy carrier and can be directly utilized as a fuel in hydrogen fuel cells (see, e.g., Jacobson, et al. Science 308, 1901-1905 (2005); United States Department of Energy. A national vision of America's transition to a hydrogen economy—to 2030 and beyond (2003); International Energy Agency (IEA), The Future of Hydrogen (2019)). Even though mature industry processes exist for the production of H₂, such as steam methane reforming, these processes have a strong dependence on unsustainable fossil resources and large CO₂ emissions, which call for greener alternative methods in producing H₂. (Turner, et al. Science 305, 972-974 (2004)).

Against this backdrop, electrocatalytic water splitting, which consists of the H₂ and O₂ (oxygen) evolution reactions (HER and OER, respectively), has attracted recent worldwide attention. (Chatenet, et al. Chem. Soc. Rev. 51, 4583-4762 (2022)). Despite the efforts devoted to developing competent electrocatalysts for both half reactions and ingenious designs of electrolyzers, the thermodynamics of water splitting dictates a large cell voltage input >1.23 V (see, FIG. 1a) and hence high energy consumption (>4.5-6 kWh per m3 H₂). (Wang, et al. Chem. Soc. Rev. 49, 9154-9196 (2020); Zhu, et al. Chem. Rev. 120, 851-918 (2020); Lagadec, et al. Nat. Mater. 19, 1140-1150 (2020); Zhang, et al. Adv. Mater. 34, 2109321 (2022)) In fact, the more energy-demanding OER produces O₂ as a low-value product at the anode while H₂ is only produced at the cathode. Therefore, there is an increasing interest in exploring alternative oxidation reactions to replace OER with lower energy input. (You, et al. Acc. Chem. Res. 51, 1571-1580 (2018)). Even more desirable is that value-added products instead of O₂ could be simultaneously obtained at the anode. Indeed, electrocatalytic oxidation of a variety of inorganic and organic feedstocks has been explored to integrate with HER to produce H₂ with lower voltage input. (You, et al. Chem. Commun. 54, 5943-5955 (2018); Li, et al. Adv. Energy. Mater. 11, 2102292 (2021)). Several electrocatalytic systems to couple the oxidative valorization of various biomass-derived intermediates have been reported (e.g., 5-hydrothymethfurfural (HMF), furfural, etc.) with HER in aqueous media. (You, et al. Angew. Chem. Int. Ed. 55, 9913-9917 (2016); You, et al. J. Am. Chem. Soc. 138, 13639-13646 (2016); Jiang, et al. ACS Energy Lett. 1, 386-390 (2016); Jiang, et al. ChemNanoMat 3, 491-495 (2017); You, et al. ACS Catal. 7, 4564-4570 (2017)). Other small molecules, such as urea, ammonia, and hydrazine, have also been reported to replace OER for more energy-efficient H₂ production from water, which produce CO₂ and/or N₂ at the anode. (Forslund, R et al. ACS Catal. 9, 2664-2673 (2019); Chen, et al. Angew. Chem. Int. Ed. 60, 7297-7307 (2021); Zhang, et al. Adv. Sci. 8, 2101299 (2021); Zhu, et al. Angew. Chem. Int. Ed. 61, e202113082 (2022)). Despite the great progress in this direction, H₂ is only produced at the cathode and most electrocatalytic systems still require a cell voltage larger than 1 V to reach an industrially relevant current density (>500 mA/cm²). Furthermore, the utilization of biomass-derived feedstocks such as HMF and furfural for the large-scale production of H₂ is still questionable because of the tremendous disparity in their scalability and the future H₂ demand. Consequently, it remains a great challenge to develop an alternative strategy to produce H₂ from water with extremely low voltage input and even more desirable is to produce H₂ at both cathode and anode.

### SUMMARY

This disclosure relates to an electrocatalytic system and method of its use for the production of hydrogen at both electrodes. The system includes a copper-silver bimetallic alloy and an aldehyde in the anolyte that in basic conditions can produce hydrogen at the cathode and the anode.

A 1^{st} aspect of the present disclosure, either alone or combined with any other aspect set forth herein, concerns an electrocatalytic system comprising an electrolyte solution, a cathode, and an anode, wherein the anode comprises a bimetallic alloy of copper and silver.

A 2^{nd} aspect of the present disclosure, either alone or combined with any other aspect set forth herein, concerns the electrocatalytic system of the 1^{st} aspect, wherein the bimetallic alloy is Cu₃Ag₇.

A 3^{rd} aspect of the present disclosure, either alone or combined with any other aspect set forth herein, concerns the electrocatalytic system of the 1^{st} or 2^{nd} aspect, wherein the bimetallic alloy is electrodeposited on a substrate of copper film (CF) or carbon paper (CP).

A 4^{th} aspect of the present disclosure, either alone or combined with any other aspect set forth herein, concerns the electrocatalytic system of the 1^{st} or 2^{nd} aspect, wherein the electrolyte solution comprises a basic salt.

A 5^{th} aspect of the present disclosure, either alone or combined with any other aspect set forth herein, concerns the electrocatalytic system of the 4^{th} aspect, wherein the basic salt is potassium hydroxide.

A 6^{th} aspect of the present disclosure, either alone or combined with any other aspect set forth herein, concerns the electrocatalytic system of the 5^{th} aspect, wherein the potassium hydroxide is of a concentration of about 1M.

A 7^{th} aspect of the present disclosure, either alone or combined with any other aspect set forth herein, concerns the electrocatalytic system of the 1^{st}, 2^{nd}, 4^{th}, 5^{th}, or 6^{th} aspect, further comprising a separator, wherein the electrolyte is comprised of a catholyte and an anolyte with the separator placed therebetween.

An 8^{th} aspect of the present disclosure, either alone or combined with any other aspect set forth herein, concerns the electrocatalytic system of the 7^{th} aspect, wherein the anolyte comprises an aldehyde.

A 9^{th} aspect of the present disclosure, either alone or combined with any other aspect set forth herein, concerns the electrocatalytic system of the 8^{th} aspect, wherein the aldehyde is an aromatic aldehyde.

A 10^{th} aspect of the present disclosure, either alone or combined with any other aspect set forth herein, concerns the electrocatalytic system of the 8^{th} aspect, wherein the aldehyde is an aliphatic aldehyde.

An 11^{th} aspect of the present disclosure, either alone or combined with any other aspect set forth herein, concerns the electrocatalytic system of the 8^{th} aspect, wherein the aldehyde is formaldehyde or paraformaldehyde.

A 12^{th} aspect of the present disclosure, either alone or combined with any other aspect set forth herein, concerns the electrocatalytic system of the 11^{th} aspect, wherein the aldehyde is formaldehyde.

A 13^{th} aspect of the present disclosure, either alone or combined with any other aspect set forth herein, concerns the electrocatalytic system of the 12^{th} aspect, wherein formaldehyde is 0.6 M or less.

A 14^{th} aspect of the present disclosure, either alone or combined with any other aspect set forth herein, concerns the electrocatalytic system of the 11^{th} aspect, wherein the aldehyde is paraformaldehyde.

A 15^{th} aspect of the present disclosure, either alone or combined with any other aspect set forth herein, concerns the electrocatalytic system of the 14^{th} aspect, wherein paraformaldehyde is of a concentration of 10 g/L or less.

A 16^{th} aspect of the present disclosure, either alone or combined with any other aspect set forth herein, concerns a method for producing hydrogen gas at an anode and a cathode, comprising: establishing an electrocatalytic system as set for in the 1^{st} or 2^{nd} aspect; applying a circulating voltage to the electrocatalytic system through the anode and the cathode; and, collecting hydrogen gas at both the anode and the cathode.

A 17^{th} aspect of the present disclosure, either alone or combined with any other aspect set forth herein, concerns a method for reducing aldehyde pollution comprising providing an aldehyde polluted solution to the electrocatalytic system of the 1^{st} or 2^{nd} aspect.

An 18^{th} aspect of the present disclosure, either alone or combined with any other aspect set forth herein, concerns a method for producing hydrogen gas from an aldehyde, comprising: establishing an electrocatalytic system, the electrocatalytic system comprising a cathode, an anode, and a electrolyte solution, wherein the anode comprises Cu₃Ag₇ and the electrolyte solution comprises an anolyte, a catholyte and a separator, wherein the anolyte and the catholyte are both of a basic pH and wherein the anolyte comprises an aldehyde; providing by electric current two electrons to the cathode to allow for the following reaction to produce hydrogen gas:

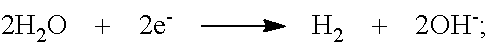

and,
   transporting the 2OH⁻ passively across the separator to the anode for the following reaction to produce hydrogen gas:

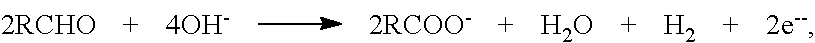

wherein R is any aliphatic and/or aromatic aldehyde); and, collecting hydrogen gas at the anode and the cathode.

A 19^{th} aspect of the present disclosure, either alone or combined with any other aspect set forth herein, concerns the method of the 18^{th} aspect, wherein the catholyte is comprised of about 1.0 M KOH.

A 20^{th} aspect of the present disclosure, either alone or combined with any other aspect set forth herein, concerns the method of the 18^{th} aspect, wherein the anolyte further comprises about 1.0M KOH.

A 21^{st} aspect of the present disclosure, either alone or combined with any other aspect set forth herein, concerns the method of the 18th, 19th, or 20^{th} aspect, wherein the aldehyde comprises formaldehyde and/or paraformaldehyde.

### BRIEF DESCRIPTION OF THE DRAWINGS

FIG. 1a shows conventional electrocatalytic water splitting under alkaline conditions.

FIG. 1b shows electrocatalytic water reduction coupled with HCHO oxidation under alkaline conditions.

FIG. 2 shows CV curves of Cu/RDE, Ag/RDE, and Cu₃Ag₇/RDE in 1.0 M KOH in the absence (dashed) and presence (solid) of 0.6 M HCHO collected at 1500 rpm and 10 m V/s. Inset shows the expanded CV of copper oxidation on Cu₃Ag₇/RDE.

FIG. 3a shows an SEM image of as-prepared Cu₃Ag₇/CF.

FIG. 3b shows XRD patterns of Cu/CP, Ag/CP, and Cu₃Ag₇/CP prior to and post electrolysis.

FIG. 3c shows CV curves of Cu₃Ag₇/CF for HCHO oxidation (red) in 1.0 M KOH with 0.6 M HCHO, Ni₃N/Ni/NF for HER (green) and Ni/NF for OER (blue) in 1.0 M KOH collected at 10 m V/s. Voltage gaps to reach 100 and 500 mA/cm² are indicated.

FIG. 3d shows the two-electrode CV curves of HER/FOR (red) and HER/OER (blue) collected at 10 mV/s, in which Cu₃Ag₇/CF and Ni₃N/Ni/NF were employed as the anode and cathode for the former while Ni/NF and Ni₃N/Ni/NF for the latter. For FOR, the anolyte was 1.0 M KOH and 0.6 M HCHO while for all the other conditions, 1.0 M KOH was the electrolyte.

FIGS. 4a-f show results of electrolysis experiments conducted in a two-electrode electrolyzer using Cu₃Ag₇/CF anode and Ni₃N/Ni/NF cathode.

FIG. 4a shows a chronoamperometric curve collected at a cell voltage of 0.6 V in 1.0 M KOH with the continuous addition of 0.1 M HCOOH, 0.1 M CH₃OH, and 0.1 M HCHO in the anode chamber.

FIG. 4b shows comparison of the experimentally measured amount of H₂ from the anode chamber with different voltage inputs. Inset shows the Faradaic efficiency of H₂ production.

FIG. 4c shows comparison of the experimentally measured H₂ amounts with the theoretical H₂ amounts calculated from the passed charge for both cathode and anode chambers during an electrolysis at a cell voltage of 0.6 V.

FIG. 4d shows Faradaic efficiencies of H₂ and formate production for five consecutive 1 h controlled-current (150 mA) electrolysis cycles.

FIG. 4e shows chronopotentiometric curves for five consecutive controlled-current electrolysis cycles conducted at 100 and 500 mA/cm2.

FIG. 4f shows chronoamperometric curves at a cell voltage of 0.6 V with the periodic replenishment of fresh HCHO back to its original 0.1 M concentration in anolyte.

FIG. 5a shows proposed mechanism of HCHO oxidation to HCOOH.

FIG. 5b shows computed adsorption energy of the H₂C(OH)O intermediate on the three model surfaces.

FIG. 5c shows optimized adsorption geometry of H₂C(OH)O on Cu₃Ag₇.

FIG. 5d shows initial (IS), transition (TS), and final (FS) states of H₂C(OH)O dehydrogenation on the three model surfaces, together with the TS structure on Cu₃Ag₇.

FIG. 5e shows H₂ formation via the Tafel step on the three surfaces.

FIG. 6a shows CV curves of Cu₃Ag₇/CF in 1.0 M KOH with 10 g/L paraformaldehyde and Ni/NF in 1.0 M KOH collected at 10 m V/s.

FIG. 6b shows Faradaic efficiencies of H₂ and formate production in the anode chamber during each electrolysis at different potential using Cu₃Ag₇/CF as the anode, 1.0 M KOH as the catholyte, and 1.0 M KOH with 10 g/L paraformaldehyde as the anolyte.

FIG. 6c shows comparative analysis of the calculated electricity consumption for H₂ production between the formaldehyde or paraformaldehyde oxidation-integrated strategy using the Ni₃N/Ni/NF(−)∥Cu₃Ag₇/CF(+) electrode couple and traditional water electrolysis (HER/OER) using the Ni₃N/Ni/NF(−)∥Ni/NF(+) electrode couple.

### DETAILED DESCRIPTION

The present disclosure concerns a copper and silver bimetallic alloy and the application of the same as a catalyst. In aspects, the present disclosure concerns Cu₃Ag₇ and its use as a catalyst. In some aspects, the present disclosure concerns providing Cu₃Ag₇ as an electrode or part thereof in an electrocatalytic system. In some aspects, Cu₃Ag₇ is provided on the surface of an electrode. In some aspects, Cu₃Ag₇ is provided as an anode. In some aspects, Cu₃Ag₇ is provided to a surface, such as glassy carbon, copper foam (CF), and/or carbon paper (CP). In some aspects, Cu₃Ag₇ is provided to a surface of a rotating disk electrode (RDE).

In some aspects, the present disclosure concerns providing Cu₃Ag₇ into a solution, such as, as an electrode in a solution. In some aspects, the solution is an electrolyte solution. In some aspects, the electrolyte solution includes a hydrogen storage molecule. In some aspects, the hydrogen storage molecule is in a liquid phase, or a solid phase, or a solid phase dissolved therein. In some aspects, the hydrogen storage molecule is an aldehyde. In some aspects, the aldehyde is an aromatic aldehyde. In some aspects, the aldehyde is an aliphatic aldehyde. Examples of suitable aldehydes are set forth in Tables 1 and 2 below:

TABLE 1
Aldehyde chemicals- aromatic

| Name (CAS) | Structure | Name (CAS) | Structure |
|---|---|---|---|
| Benzaldehyde (100-52-7) | 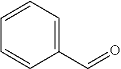 | 4-Nitrobenzaldehyde (555-16-8) | 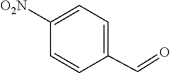 [SMILES: O=Cc1ccc([N+](=O)[O-])cc1] |
| 4-Chlorobenzaldehyde (104-88-1) | 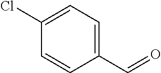 | 4-Bromobenzaldehyde (1122-91-4) | 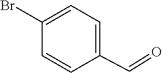 |
| 4-cyanobenzaldehyde (105-07-7) | 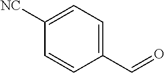 | 4- Methoxybenzaldehyde (123-11-5) | 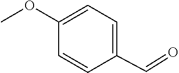 |
| Methyl 4- formylbenzoate (1057-08-0) | 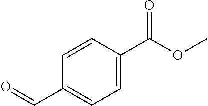 | 4-(Dimethylamino) benzaldehyde (100-10-7) | 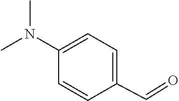 |
| p-Tolualdehyde (104-87-0) | 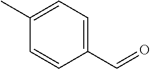 | 2,6-Dimethyl- benzaldehyde (1123-56-4) | 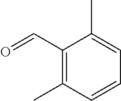 |
| 1-Formyl-4- trifluoromethylbenzene (455-19-6) | 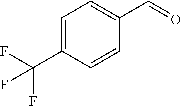 [SMILES: O=Cc1ccc(C(F)(F)F)cc1] | 2,4,6-trimethyl- benzaldehyde (487-68-3) | 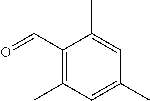 |
| 4-Fluorobenzaldehyde (459-47-4) | 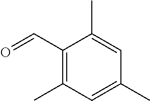 | 3,5-Dimethyl- benzaldehyde (5779-95-3) | 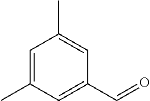 |

TABLE 2
Aldehyde chemicals - aliphatic:

| Name (CAS) | Structure | Name (CAS) | Structure |
|---|---|---|---|
| 5-Bromofuran-2- carbaldehyde (1899-24-7) | 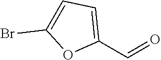 | Hydrocinnamaldehyde (104-53-0) | 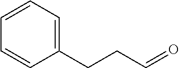 |
| Furan-2,5- dicarbaldehyde (823-82-5) | 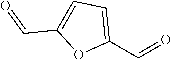 | Phenylacetaldehyde (122-78-1) | 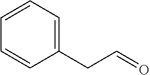 |
| 5-Ethyl-2- furaldehyde (23074-10-4) | 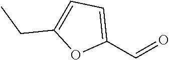 | Cyclopropanecarbaldehyde (1498-69-6) | 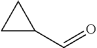 |
| Furfural (98-01-1) | 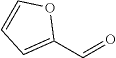 | 3-Methylcrotonaldehyde (107-86-8) | 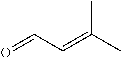 |
| 5-Hydroxymethyl furfural (67-47-0) | 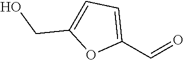 | 1,3-Benzothiazole-2- carbaldehyde (6639-57-2) | 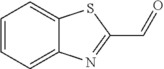 [SMILES: O=Cc1nc2ccccc2s1] |
| Butyraldehyde (123-72-8) | 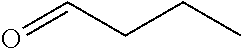 | Formaldehyde (50-00-0) | HCHO |

In some aspects, the liquid phase hydrogen storage molecule is formaldehyde and/or includes formaldehyde.

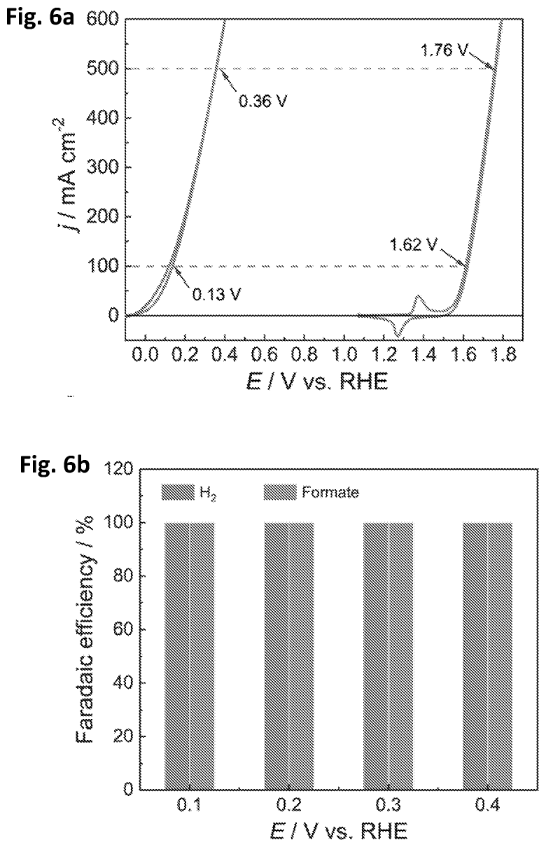

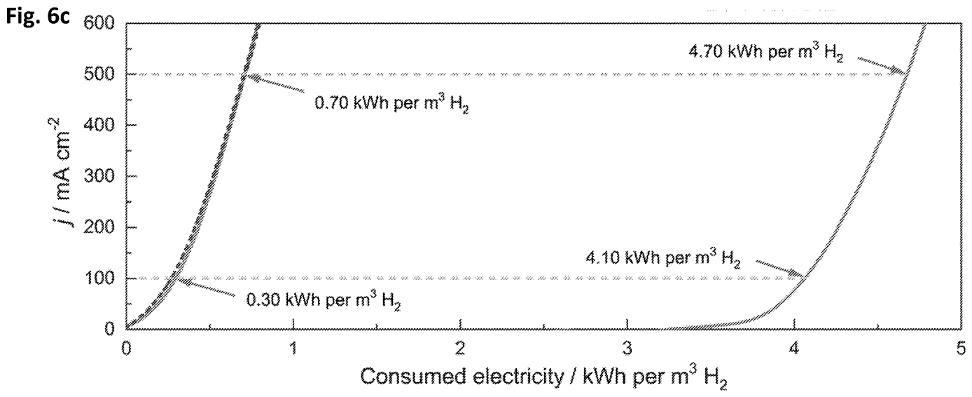

In some aspects, the hydrogen storage molecule may include paraformaldehyde. As set forth in the working Examples herein, the hydrogen storage molecule may be a solid phase aldehyde or a solid phase dissolved in the basic electrolyte solution. For example, the working Examples show that solid paraformaldehyde can be utilized in the electrocatalytic system and yield H₂ production at both the cathode and anode. Cu₃Ag₇/RDE still exhibited excellent electrocatalytic activity for the oxidation of paraformaldehyde. Concentration dependence experiments indicated that 10 g/L paraformaldehyde resulted in the highest oxidation current density (60 mA/cm²) on Cu₃Ag₇/RDE in 1.0 M KOH. FIG. 6a compares the CV curves collected on Cu₃Ag₇/CF and Ni/NF in the presence and absence of 10 g/L paraformaldehyde, respectively. It is apparent that much smaller potentials of 0.13 and 0.36 V vs RHE are required to produce 100 and 500 mA/cm², respectively, than those required for OER on Ni/NF. Nearly unity Faradaic efficiencies were obtained for both hydrogen and formate production when paraformaldehyde was employed as the feedstock and Cu₃Ag₇/CF as the anode electrocatalyst at different applied potentials from 0.1 to 0.4 V vs RHE (FIG. 6b). When paraformaldehyde was used, the yields of methanol and formate from the competing Cannizzaro reaction were much lower than those directly using HCHO solutions, suggesting an advantage of using paraformaldehyde as the feedstock for the dual HER strategy. The long-term stability test of electrolysis using PFA was also carried out using a flow cell consisting of AEM and Ni₃N/Ni/NF(−)∥Cu₃Ag₇/CF(+) electrode couple in a zero-gap configuration. The electrolysis was performed at 100 mA cm⁻² with 1.0 M KOH as the catholyte and 1.0 M KOH plus 10.0 g/L PFA as the anolyte, both of which were fed into the cell at a flow rate of 50 mL min-1. The electrolyte was refreshed every 24 h. The dual hydrogen production strategy (HER/FOR) using the Ni₃N/Ni/NF(−)∥Cu₃Ag₇/CF(+) electrode couple can maintain a low voltage input (0.4-0.6 V without iR correction) to deliver 100 mA cm-2 over 260 h, indicating the great robustness of the electrocatalysts for dual hydrogen production.

In some aspects, the electrolyte solution is of a basic pH. In some aspects, the pH of the electrolyte solution is above 7, such as 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8, 12.9, 13.0, 13.1, 13.2, 13.3, 13.4, 13.5, 13.6, 13.7, 13.8, 13.9, and 14.0. In some aspects the electrolyte solution include 0.3-4.0 M of a basic salt, including about 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, and 3.9 M. In some aspects, the basic salt includes a hydroxide, such as potassium hydroxide, or sodium hydroxide. As set forth in the working examples, an electrolyte solution that included about 1.0 M KOH allowed for the system to generate hydrogen at both the anode and the cathode.

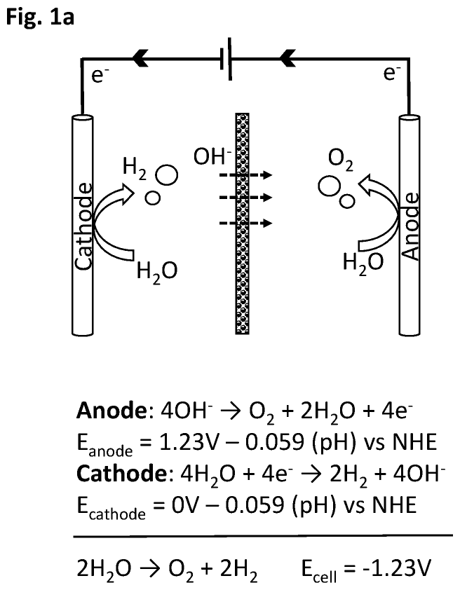

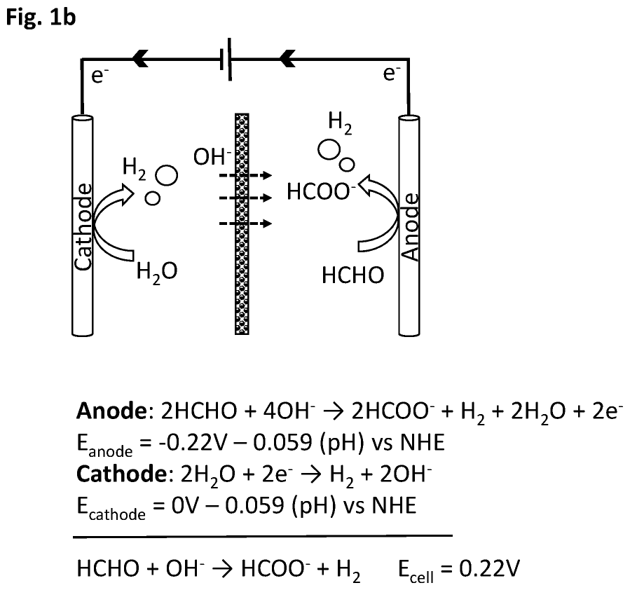

In some aspects, the electrolyte is divided into a catholyte solution and an anolyte solution. In some aspects, both the catholyte and the anolyte solutions are basic. In some aspects, both the anolyte and the catholyte include the same basic salt. In some aspects, the catholyte and the anolyte include the same salt at the same molarity. For example, as set forth in the examples, both the catholyte and the anolyte include 1.0 M KOH. In some aspects, the anolyte only include the liquid phase hydrogen storage molecule. For example, as set forth in the examples, the anolyte includes an aldehyde, such as formaldehyde, as the hydrogen storage molecule. As set forth in FIG. 1b, the reaction at the anode allows for formation of H₂ via oxidation of the hydrogen storage molecule. The oxidation occurs due to the splitting of water from two electrons into H₂ and the oxidizing OH⁻ molecules. In some aspects, the anode chemistry is as follows:

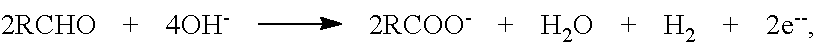

(R being any aliphatic and/or aromatic group see, e.g., tables above)), while at the cathode the following reaction occurs:

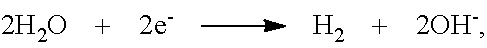

thereby accounting for hydrogen production at both the anode and the cathode.

In some aspects, the present disclosure concerns an electrocatalytic system of an anode, a cathode, and an electrolyte solution. In some aspects, a separator may be placed between the anode and the cathode, thereby separating an anolyte and a catholyte. Separators are understood in the art to allow passage ions such as OH⁻ through, but otherwise keep the anolyte and catholyte separated. In some aspects, the separator is a frit. In some aspects, the separator is of a mesh or polymeric material, such as a microporous membrane of a polyolefin, such as polyethylene and/or polypropylene. In some aspects, the separator is an anion exchange membrane. In some aspects, the separator is a polymer membrane with positively charged cation groups thereon that attract and allow passage of negatively charged anions therethrough.

In some aspects, the anolyte and the catholyte are both basic and/or of the same basic salt concentration. In some aspects, the anolyte may include about 30-80% relative concentration of hydrogen storage molecule therein, including about 35, 40, 45, 50, 55, 60, 65, 70, and 75 (±4%). For example, for every 1 M of basic salt, the anolyte may further include between about 0.3 and 0.8 M hydrogen storage molecule, including about 0.35, 0.4, 0.45, 0.5, 0.55, 0.6, 0.65, 0.7, and 0.75 M (±0.4 M).

In some aspects, the electrocatalytic systems of the present disclosure may include three electrodes: a working electrode, a counter electrode, and a reference electrode. As set forth in the working examples, the Cu₃Ag₇ electrode and/or coated electrode can function as a working electrode, with a Ni₃N/N and/or Ni₃N/N/NF electrode functioning as a counter electrode. In some aspects, a reference electrode, may be included to monitor the working electrode. The inclusion of such is understood in the art.

In some aspects, the present disclosure concerns an electrocatalytic system of two electrodes in contact with a basic electrolyte that includes a liquid phase hydrogen storage molecule in the anolyte that thereby produces hydrogen gas (H₂) at both electrodes. In aspects, the anode includes Cu₃Ag₇ and the cathode includes Ni₃N/Ni to drive production of hydrogen under alkaline conditions. In aspects, the electrocatalytic system of the present disclosure can produce hydrogen with an apparent 200% Faradaic efficiency and reach industrially relevant current densities of 100 and 500 mA/cm² at cell voltages of only 0.22 and 0.60 V, respectively. Overall, the energy consumption of this two-electrode electrolyzer for hydrogen production is merely 0.30 and 0.70 kWh per m³ hydrogen at current densities of 100 and 500 mA cm⁻², respectively, much lower than the theoretical energy demand of overall water splitting electrolysis (2.93 kWh/1 m³ H₂).

In aspects, the electrocatalytic system of the present disclosure includes an anode of Cu₃Ag₇. In some aspects, Cu₃Ag₇ is applied to a surface, such as by electrodeposition. In some aspects, the electrode may include surface deposition or a surface covering/partial covering of Cu₃Ag₇ applied. In some aspects, Cu₃Ag₇ is applied to a surface of a RDE. In some aspects, Cu₃Ag₇ is applied to CF or a CF RDE. In some aspects, Cu₃Ag₇ is applied to CP or a CP RDE.

In some aspects, the electrocatalytic systems of the present disclosure include a Ni₃N/Ni electrode. In some aspects, the electrocatalytic systems of the present disclosure include a cathode of Ni₃N/Ni. As set forth in the working examples, Ni₃N/Ni synthesized from the electrodeposition of Ni particles on a nickel foam (NF) followed by thermal nitridation. (see, e.g., Song, et al. Nat. Commun. 9, 4531 (2018)). As set forth in the working examples, a piece of clean nickel foam was used as the working electrode with a carbon rod used as the counter electrode. The Ni/NF was synthesized through electrodeposition at a constant current density of −1.0 A cm-2 for 500 s in a two-electrode cell containing NiCl₂ (0.1 M) and NH₄Cl (2.0 M) under Ar without stirring. The Ni₃N/Ni/NF was obtained from the thermal annealing of Ni/NF under an NH₃ flow at 300° C. for 6 hours with a ramping rate of 10° C. min⁻¹.

In some aspects, the electrocatalytic system utilizes a liquid phase hydrogen storage molecule to produce hydrogen at both the anode and the cathode of the system. In some aspects, the liquid phase hydrogen storage molecule is an aldehyde. As set forth in the working examples, the use of formaldehyde (HCHO) as an exemplary aldehyde, achieved production of H₂ at both electrodes. In some aspects, selection of an aldehyde liquid hydrogen storage molecule was inspired by advances in hydrogen generation from liquid-phase hydrogen storage molecules, such as NaBH₄, NH₃BH₃, and HCOOH, which are able to release hydrogen under thermocatalytic conditions. (Zhang, et al. ACS Appl. Mater. Interfaces 12, 9376-9386 (2020); Wang, et al. ACS Catal. 9, 1110-1119 (2018); Fu, et al. J. Am. Chem. Soc. 140, 10034-10042 (2018); Choi et al. ACS Catal. 9, 819-826 (2018); Li, et al. Adv. Mater. 31, 1806781 (2019)). Among those liquid hydrogen storage molecules, aldehydes, such as formaldehyde (HCHO), provide appeal as the partial HCHO oxidation (FOR) to formate is also able to release hydrogen at the anode with a very small thermodynamic potential (HCHO+2OH—→HCOO—+½H₂+H₂O+e−, E=−0.22 V vs RHE, FIG. 1b). (Machida et al. Bull. Chem. Soc. Jpn. 58, 2043-2050 (1985)).

Furthermore, aldehydes, such as HCHO, are a frequently low-cost chemical feedstock with a large annual yield, while its oxidation product formate (and later formic acid) is a more valuable chemical. (Trincado, et al. Phys. Sci. Rev. 3, 20170013 (2018); Bulushev, et al. ChemSusChem 11, 821-836 (2018)) Finally, coupling FOR with HER for hydrogen production may also provide environmental benefits if toxic formaldehyde residues in wastewater pollutants could be adopted as the feedstock. Even though hydrogen generation from the electrochemical oxidation of HCHO has been reported on a few monometallic electrodes, it remains less explored to couple it with water reduction for dual hydrogen production at both anode and cathode as set forth herein. (Meerakker, et al. J. Appl. Electrochem. 11, 387-393 (1981); Beltowska-Brzezinska. Electrochim. Acta 30, 1193-1198 (1985); M. Beltowska-Brzezinska et al. J. Electroanal. Chem. 183, 167-181 (1985)).

In some aspects, the present disclosure concerns methods for producing hydrogen (H₂) at two electrodes of an electrocatalytic system. In some aspects, the methods include preparing or arranging the catalytic system as set forth herein and providing a current thereto to generate hydrogen at the cathode and anode. For example, providing an anode of Cu₃Ag₇ or a coating thereof in or partially in an anolyte of a basic salt and a hydrogen storage molecule with a cathode of Ni₃N/Ni or a Ni₃N/Ni coated NF in or partially in a catholyte of a basic salt, separated by a separator and with both operably connected to an electrical power source, allows for the reactions as described above with the hydrogen storage molecule to release hydrogen at both electrodes.

In some aspects, the methods of the present disclosure include providing a voltage input into the electrocatalytic system to provide for production of H₂ at both electrodes. As described herein, the systems of the present disclosure do not require high amounts of voltage. For example, as set forth herein a low voltage input of about 0.4 to about 0.6 V can deliver 100 mAcm⁻² over 260 hours, while also provide for about 200% Faradaic efficiency.

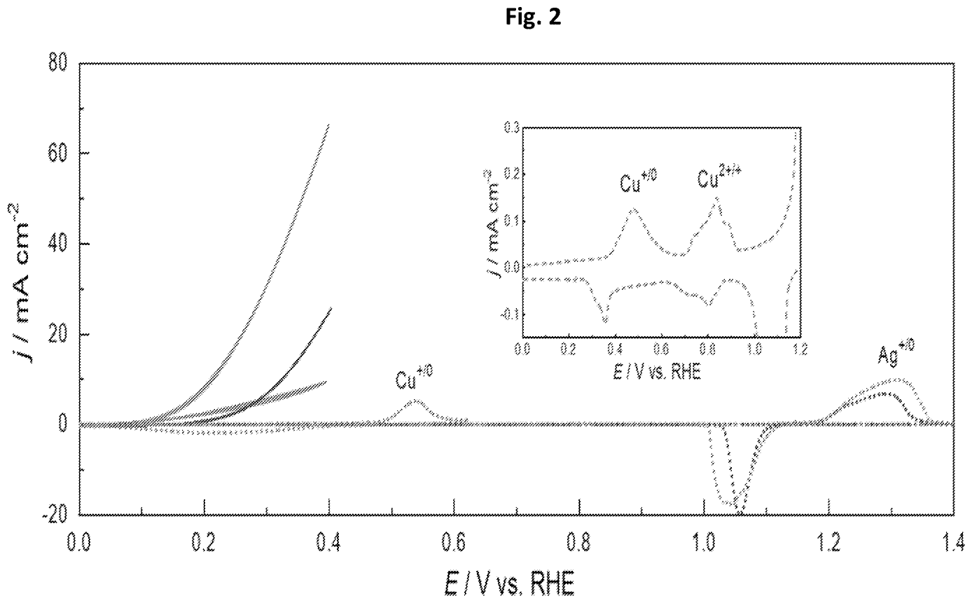

Screening of catalysts for formaldehyde oxidation. Inexpensive nitrate salts of copper and silver were utilized as the feedstocks to first prepare the corresponding monometallic electrocatalysts on glassy carbon rotating disk electrode (RDE) via a facile electrodeposition method (see Examples herein). As shown in FIG. 2, in the absence of HCHO, Cu/RDE showed a well-defined oxidation feature from Cu⁰ to Cu⁺ at ca. 0.5 V vs RHE in 1.0 M KOH; while the oxidation peak of Ag⁰ to Ag⁺ from Ag/RDE did not appear until ~1.2 V vs RHE. Upon the addition of 0.6 M HCHO, an apparent anodic current rise was observed beyond the onset potential (defined at 0.1 mA cm⁻²) of 0.05 V vs RHE on Cu/RDE and a current density of 10 mA/cm² was obtained at 0.4 V vs RHE, indicating the electrochemical oxidation of HCHO on Cu/RDE. Despite the more positive onset potential (0.2 V vs RHE) for HCHO oxidation, a much more rapid current rise was observed on Ag/RDE, which was able to produce an anodic current density of 26 mA/cm² at 0.4 V RHE. The differences in onset potential and anodic current rise of HCHO oxidation on Cu/RDE versus Ag/RDE prompted us to finely tune the ratio between Cu and Ag precursors in electrodeposition, aiming to synthesize a bimetallic CuAg electrocatalyst with optimized activity.

By systematically varying the Cu/Ag ratio from 9/1 to 1/9, all the bimetallic CuAg/RDE electrodes possess similar electrochemical double layer capacitances (Cdl=0.7-0.8 mF/cm2), close to those of the pristine monometallic samples (0.5-0.6 mF/cm2). Therefore, these bimetallic CuAg/RDE samples have a similar electrochemical active surface area, which allows a fair comparison of their electrocatalytic activity of HCHO oxidation based on the measured geometric current density. Based on cyclic voltammograms (CVs) of all the CuAg/RDE samples as well as Cu/RDE and Ag/RDE measured under the same condition (0.6 M HCHO in 1.0 M KOH), it was apparent that Cu₃Ag₇/RDE exhibited the best performance. The ICP-MS analysis result of Cu₃Ag₇/RDE confirmed the Cu/Ag ratio was 3:7. Therefore, all the subsequent electrochemical HCHO oxidation studies were carried out using Cu₃Ag₇ as the optimal electrocatalyst.

In the absence of HCHO, Cu₃Ag₇/RDE still retained the typical copper redox features of Cu^{+/0} and Cu^{2+/+} between 0.4 and 1.0 V vs RHE but with suppressed current density (FIG. 2 inset) relative to that of Cu/RDE in 1.0 M KOH. Further positive scanning revealed an analogous oxidation feature of Ag⁰ to Ag⁺ beyond 1.2 V vs RHE as observed for Ag/RDE. The addition of 0.6 M HCHO resulted in a drastic anodic current rise starting at ca 0.1 V vs RHE, which was able to reach 66 mA/cm² at 0.4 V vs RHE (FIG. 2), substantially higher than those obtained on monometallic Cu/RDE (10 mA/cm²) and Ag/RDE (26 mA/cm²) at the same potential.

Using Cu₃Ag₇/RDE as a model electrode, the impact of HCHO concentration on the obtained current density was investigated and it was found that 0.6 M HCHO produced the maximum current density at 0.4 V vs RHE in 1.0 M KOH. Increasing the HCHO concentration beyond 0.6 M resulted in decreased anodic current, likely due to more disproportionation of HCHO at higher concentration (Cannizzaro reaction). (Martin, et al. Aust. J. Chem. 7, 335-347 (1954)). Next, the impact of OH-concentration was also probed. In 1.0 M NaClO₄, no anodic current was observed on Cu₃Ag₇/RDE between 0 and 0.4 V vs RHE when 0.1 M HCHO was added. However, a slight increase to 1 mM [OH-] was able to produce noticeable anodic current at 0.4 V RHE. A higher HCHO oxidation current was observed along the increase in [OH—]. Overall, these results demonstrate that an alkaline condition is necessary for the electrochemical oxidation of HCHO on Cu₃Ag₇/RDE.

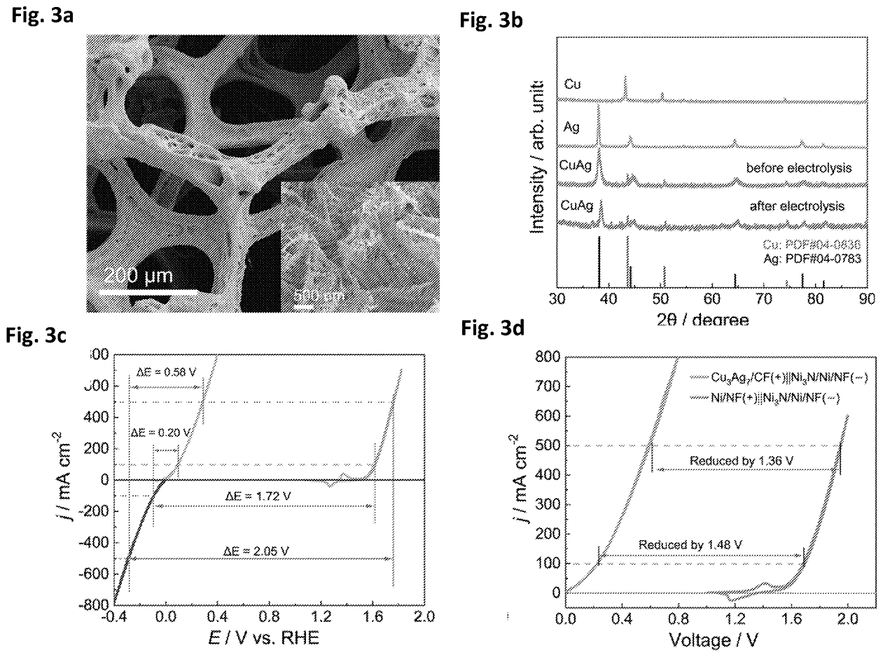

Electrolysis performances. With the identified Cu/Ag ratio, electrodeposition of Cu₃Ag₇ on highly porous was next sought along with conductive substrates for electrolysis studies. To avoid the introduction of other metal composites, commercially available copper foam was adopted as the catalyst support and current collector. A slightly modified electrodeposition approach was utilized to prepare Cu₃Ag₇ on copper foam (CF) and the resulting electrode was named as Cu₃Ag₇/CF (see Examples herein). The scanning electron microscopy (SEM) image of a pristine copper foam indicates its porous skeleton with smooth surface. After the electrodeposition of Cu₃Ag₇, the as-prepared Cu₃Ag₇/CF shows a nearly complete coverage of the copper foam by pine needle-like electrodeposits (FIG. 3a). Energy-dispersive X-ray spectroscopy analysis of Cu₃Ag₇/CF resulted in a Cu/Ag ratio very close to 3:7, in agreement with the ICP-MS results of Cu₃Ag₇/RDE. To shed light on the crystallinity of electrodeposited Cu₃Ag₇, X-ray diffraction was performed. In this case, carbon paper (CP), instead of copper foam, was used as the catalyst support, in order to avoid the interference of the background signal from the copper foam. The obtained XRD patterns of Cu/CP, Ag/CP, and Cu₃Ag₇/CP included in FIG. 3b confirmed that the bimetallic sample consists of both crystalline Cu (JCPDS Card no. 04-0836) and Ag (JCPDS Card no. 04-0783). (Dutta, A et al. ACS Catal. 6, 3804-3814 (2016); Dutta, et al. ACS Catal. 8, 8357-8368 (2018)). The most prominent peaks at around 44° and 38° are corresponding to the (111) facets of Cu and Ag, respectively, which are preserved in Cu₃Ag₇/CP. To further investigate the structure of Cu₃Ag₇/CF, high-resolution transmission electron microscopy (HRTEM) combined with selected area electron diffraction (SAED) were performed. A clear dendritic structure in line with the SEM images was seen (FIG. 3a). HRTEM images showed the well-resolved lattice fringes with an inter-planar distance of 0.237 and 0.208 nm corresponding to the (111) crystal plane of cubic Ag and Cu, respectively. The distinct diffraction rings from SAED showed the polycrystalline nature and could be indexed to the (111), (200), (220), and (311) planes of Ag and Cu36, respectively, in good agreement with the XRD results. High-angle-annular dark-field STEM (HAADF-TEM) and energy-dispersive X-ray spectroscopy (EDX) element mapping images reveal a uniform distribution of Cu and Ag throughout the dendrites.

Next, a two-compartment electrochemical cell (H-cell) with an anion exchange membrane was used to investigate the electrochemical HCHO oxidation on Cu₃Ag₇/CF. As shown in FIG. 3c, the CV curve of Cu₃Ag₇/CF collected in 1.0 M KOH with 0.6 M HCHO presents a nearly zero onset potential and very steep anodic current increase, reaching 100 and 500 mA/cm² at merely 0.10 and 0.28 V vs RHE, respectively. In sharp contrast, when electrodeposited nickel nanoparticles on a nickel foam (Ni/NF) were employed as the OER electrocatalysts, much higher potentials (1.62 and 1.76 V vs RHE) were required to reach the same current densities (100 and 500 mA/cm²). The earth-abundant HER electrocatalyst composed of interfaced Ni₃N and Ni on nickel foam (Ni₃Ni/Ni/NF) in 1.0 M KOH had been reported previously. (Song, et al. Nat. Commun. 9, 4531 (2018)). For the sake of comparison, the CV curve of Ni₃N/Ni/NF for the cathodic hydrogen evolution was also included in FIG. 3c. With the above CVs, it was deduced that the voltage inputs for HER coupled with FOR would be much smaller to reach industrially relevant current densities like 100 and 500 mA/cm², requiring only 0.20 and 0.58 V, respectively, when Cu₃Ag₇/CF and Ni₃N/Ni/NF were employed as the anode and cathode electrocatalysts, respectively. However, much larger voltages were demanded (>1.7 V) for water splitting (HER/OER) to produce the same current density when using the Ni/NF (anode) and Ni₃N/Ni/NF (cathode) catalyst couple. Indeed, as plotted in FIG. 3d, when a two-electrode electrolyser of FOR/HER was assembled using Cu₃Ag₇/CF as the anode and Ni₃N/Ni/NF as the cathode, the corresponding CV curve collected in 1.0 M KOH with 0.6 M HCHO only required cell voltages of 0.22 and 0.60 V to deliver the current densities of 100 and 500 mA cm⁻², respectively, yet much higher cell voltages of 1.70 and 1.96 V were needed for conventional water splitting electrolysis. In short, this FOR/HER strategy using the Cu₃Ag₇/CF(+)∥Ni₃N/Ni/NF(−) electrode couple exhibited great superiority comparing to reported systems of HER integrated with the oxidation of various inorganic and organic feedstocks, in terms of applied voltage and Faradaic efficiency for hydrogen production.

Products analysis. Since the commercially purchased HCHO (37 wt. % in H₂O) contains methanol as a stabilizer and HCHO oxidation will produce formate under alkaline conditions, it is important to determine if Cu₃Ag₇/CF can catalyze the oxidation of methanol and formate within this small potential window. CV of Cu₃Ag₇/RDE from 0 to 0.4 V vs RHE in 1.0 M KOH was first collected after the addition of 0.1 M formic acid, 0.1 M methanol, and 0.1 M HCHO, respectively. The increase in anodic current on Cu₃Ag₇/RDE was negligible upon the addition of either methanol or formic acid. However, a rapid anodic current rise was observed once HCHO was added, indicating that Cu₃Ag₇/RDE could effectively catalyze the electrooxidation of HCHO but not formic acid or methanol within this potential region, likely due to the smaller bond dissociation energy of C—H bond in H—CHO (88.0±0.2 kcal mol-1) compared to all the bonds in methanol and formic acid. (Blanksby et al. Acc. Chem. Res. 36, 255-263 (2003)).

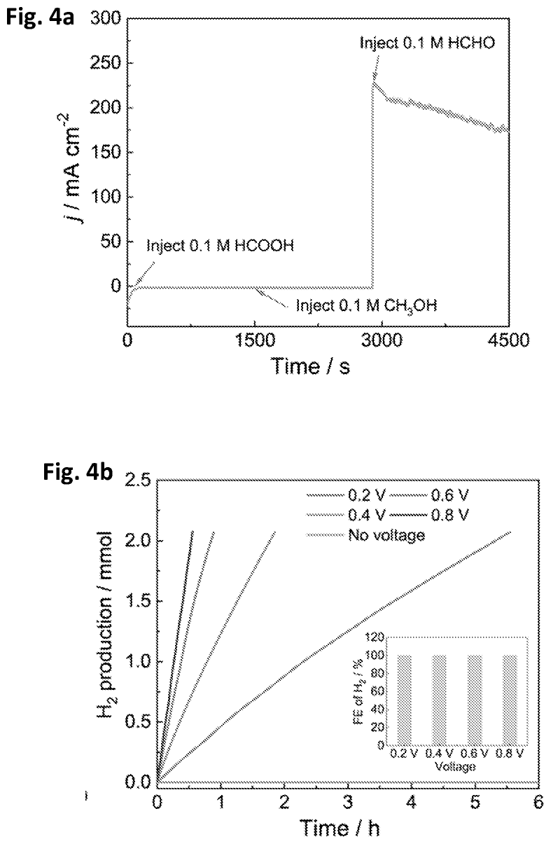

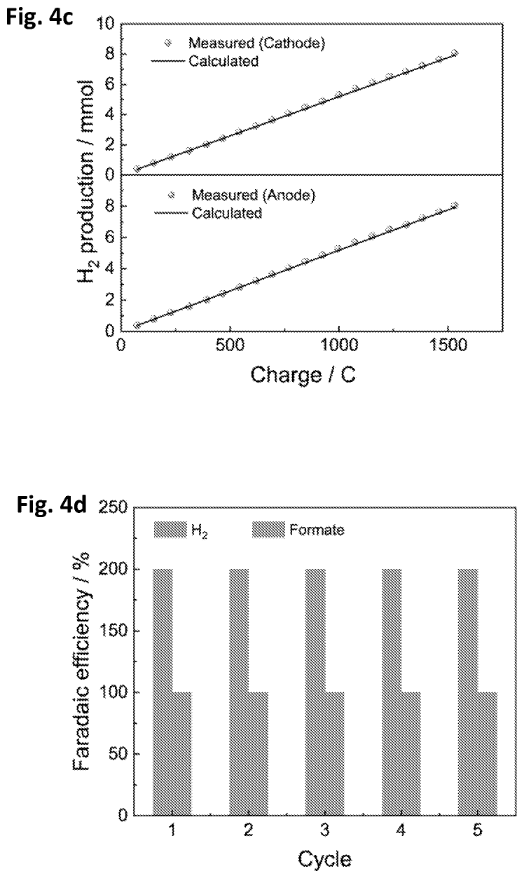

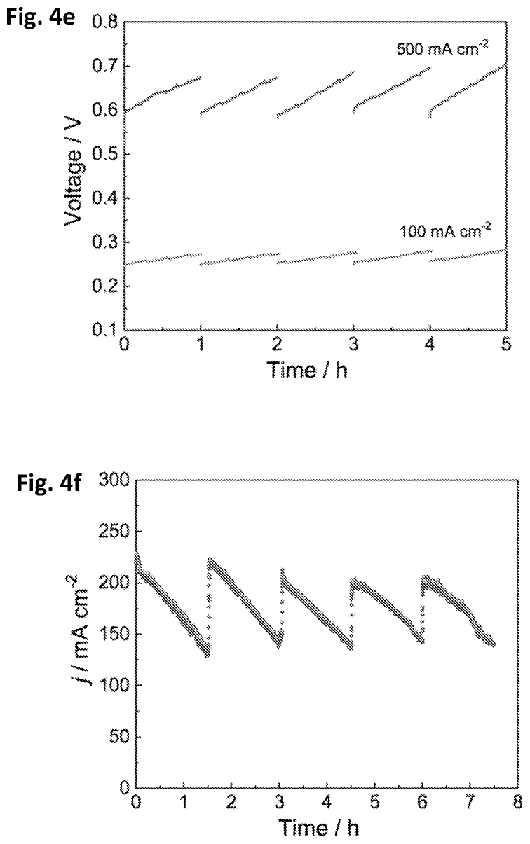

FIG. 4a presents the chronoamperometry curve of Cu₃Ag₇/CF in 1.0 M KOH upon the continuous addition of 0.1 M formic acid, 0.1 M methanol, and 0.1 M HCHO. It was apparent that negligible anodic current increase was observed upon the addition of either formic acid or methanol with a voltage input of 0.6 V, indicating that Cu₃Ag₇/CF was not able to catalyze their electrochemical oxidation with this small voltage. In contrast, the addition of 0.1 M HCHO led to an immediate anodic current rise to 230 mA/cm². These results show that Cu₃Ag₇/CF possesses an excellent selectivity towards the electrochemical oxidation of HCHO with low voltage input, which is not affected by the presence of methanol and formate.

Gas chromatography was also performed to confirm and quantify the amount of produced gas from the H-cell where Cu₃Ag₇/CF was employed as the anode and Ni₃N/Ni/NF as the cathode in a two-electrode configuration. As shown in FIG. 4b, without applied voltage, no hydrogen was detected, suggesting that Cu₃Ag₇/CF was not able to thermocatalytically drive HCHO oxidation in 1.0 M KOH with 0.6 M HCHO at room temperature. Along the increase of voltage input from 0.2 to 0.8 V, because of faster hydrogen production rate, continuously decreased electrolysis time was needed to produce 2 mmol hydrogen from the anode chamber. Comparing the experimentally measured amount of hydrogen and the calculated amount of hydrogen based on passed charge during each electrolysis of different voltage inputs (0.2-0.8 V) confirmed that 100% Faradaic efficiency (FE) was achieved for anodic hydrogen production within the entire voltage range (FIG. 4b inset). In the meantime, cathodic hydrogen production from the Ni₃N/Ni/NF cathode was also able to produce hydrogen with a 100% FE. For instance, FIG. 4c overlaps the measured hydrogen amounts over the theoretical hydrogen amounts along the passed charge for both cathode and anode chambers during an electrolysis carried out at 0.8 V when 1.0 M KOH with 0.6 M HCHO was used as the anolyte and 1.0 M KOH as the catholyte. The nearly perfect alignment of the hydrogen amounts for both chambers confirmed that 100% FE of hydrogen production was realized for both electrodes and collectively 200% FE for overall hydrogen generation.

The organic products in the liquid phase of the anode chamber were determined and quantified to assess the carbon balance of electrolysis. The amounts of methanol and formate were determined from 1H NMR measurements using t-butanol as an internal standard. Besides the quantity resulting from the Cannizzaro reaction, all the additional formate was produced from the electrochemical HCHO oxidation. As shown in FIG. 4d, 100% FE of formate production was achieved for five consecutive 1 h controlled-current electrolysis (150 mA) using the Cu₃Ag₇/CF and Ni₃N/Ni/NF couple but fresh electrolyte for each cycle. In the meantime, 200% FE of overall hydrogen production was retained for all the five cycles as well. Further, the remaining HCHO was quantified via UV-vis absorption measurement following the Hantzsch reaction (see Examples herein), (Nash, et al. Biochem. J. 55, 416-421 (1953)) using a pre-established calibration curve. From the results, it was concluded that 100% carbon balance of HCHO was maintained for the above five consecutive electrolysis cycles using the same electrode couple.

The stability of the Cu₃Ag₇/CF and Ni₃N/Ni/NF electrode couple was further tested by both chronopotentiometry and chronoamperometry electrolysis. FIG. 4e shows nearly identical chronopotentiometric curves for five consecutive controlled-current electrolysis conducted at 100 and 500 mA/cm² in a fresh anolyte (1.0 M KOH and 0.6 M HCHO) of each cycle using the same electrode couple. In addition, a 7.5 h chronoamperometry experiment was carried out in the same electrolyte at a cell voltage of 0.6 V with the periodic replenishment of fresh HCHO back to its original 0.1 M concentration. Immediate resume of the anodic current was observed for each period (FIG. 4f). Post-electrolysis characterization of Cu₃Ag₇/CF displayed negligible changes in morphology, crystallinity, and electrochemical double-layer capacitance (FIG. 3b). Overall, these results corroborate the superior structural robustness and mechanical stability of Cu₃Ag₇/CF for long-term electrochemical HCHO oxidation for anodic hydrogen production with low voltage input.

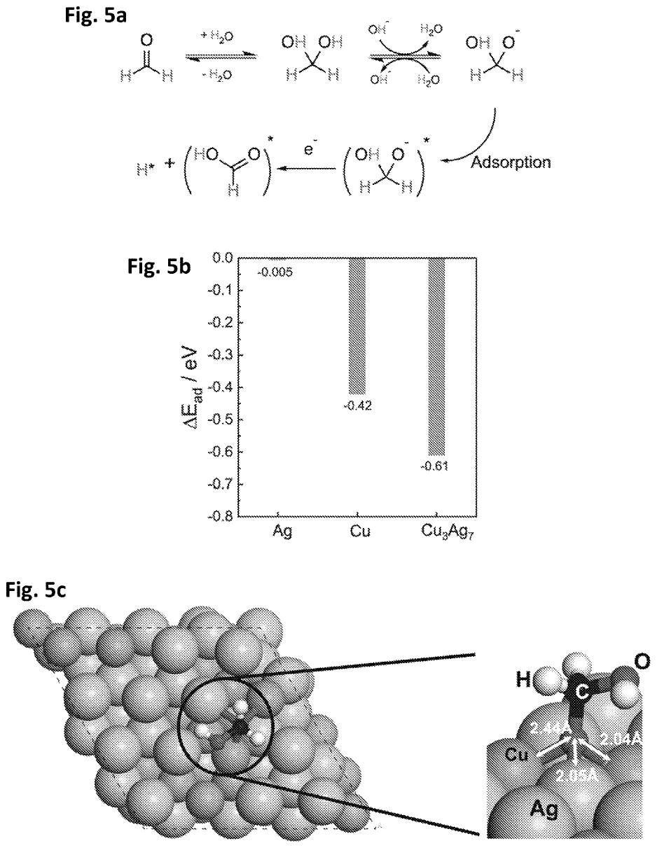

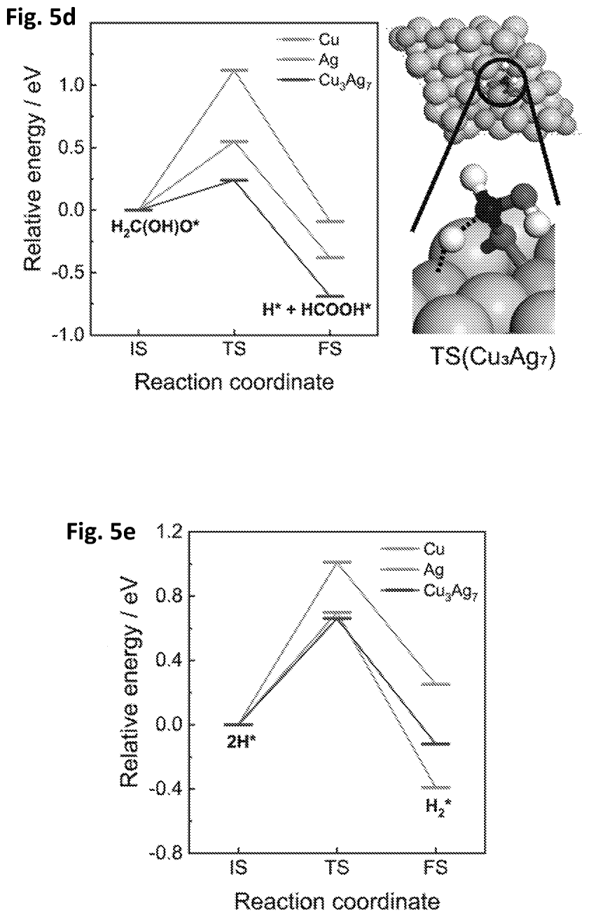

Theoretical computations. To shed light on the improved performance of the bimetallic Cu₃Ag₇/CF relative to monometallic Cu/CF and Ag/CF in the anodic hydrogen production from electrocatalytic HCHO oxidation, density functional theory (DFT) computation was performed to examine the structure and energetics of key steps during FOR. Because only a small voltage is needed to drive FOR, one can assume that the electrocatalytic reaction proceeds close to the thermodynamic limit. Under thermal conditions, the commonly accepted mechanism of FOR is that HCHO first becomes hydrated and deprotonated in the alkaline solution to yield the H₂C(OH)O anion, which then adsorbs on the catalyst surface. (Kapoor, J. Phys. Chem. 99, 6857-6863 (1995); ten Kortenaar, et al. Langmuir 18, 10279-10291 (2002)) The resulting H₂C(OH)O* intermediate is dehydrogenated via C—H cleavage to yield HCOOH* and H* (FIG. 5a), which is a step to focus on. Experimental characterization showed that the (111) facets are preferentially exposed for the Cu, Ag, and Cu₃Ag₇ catalysts, so the (111) surfaces were used to compare the three catalysts. First, the relative adsorption energy of the H₂C(OH)O* intermediate were compared: as shown in FIG. 5b, adsorption on Cu₃Ag₇ is most preferred, with the O group anchored at the Cu₂Ag₁ hollow site; the top view shows a clear staggered conformation of the H₂COH group relative to the Cu₂Ag₁ site (FIG. 5c), distinct from the more eclipsed conformations on Cu (111) and Ag (111). Analysis of the projected density of states of the anchored O group of H₂C(OH)O* at the Cu₂Ag₁ site indicates that there are strong orbital mixings of O 2p states with Cu 3d states from −1.5 to −1.0 eV as well as with Ag 4d states from −6 to −5 eV and −4 to −3 eV. In other words, the existence of the separate two d-bands on the bimetallic surface provides more flexibility in adsorbing and stabilizing the H₂C(OH)O* intermediate. Indeed, C—H cleavage is much more facile on Cu₃Ag₇ from the staggered adsorption conformation (FIG. 5d). After C—H cleavage, formation of hydrogen from two H* was found to be facile as well on Cu₃Ag₇ (FIG. 5e): the energy barrier is 0.66 eV, which is expected to be further lowered when entropy is taken into account. To complete the reaction, HCOOH* will desorb from the surface and then deprotonate to form formate in the solution.

Electrocatalytic paraformaldehyde oxidation and energy efficiency analysis. The promising activity of Cu₃Ag₇ towards HCHO oxidation to produce hydrogen, corroborated by the DFT results, prompted us to further expand the substrate scope. There was motivation to explore the possibility of utilizing paraformaldehyde as the feedstock for the following reasons. In contrast to HCHO aqueous solutions with limited concentration (e.g., 37 wt %) and containing methanol as the stabilizer, paraformaldehyde is solid under ambient conditions, possessing much higher mass density and also lower cost. (Fetzer, et al. ChemCatChem 13, 1317-1325 (2021)). It is known that HCHO can be released from paraformaldehyde when dissolved in an aqueous solution. Cu₃Ag₇/RDE still exhibited excellent electrocatalytic activity for the oxidation of paraformaldehyde, superior to Cu/RDE and Ag/RDE. Concentration dependence experiments indicated that 10 g/L paraformaldehyde resulted in the highest oxidation current density (60 mA/cm²) on Cu₃Ag₇/RDE in 1.0 M KOH. FIG. 6a compares the CV curves collected on Cu₃Ag₇/CF and Ni/NF in the presence and absence of 10 g/L paraformaldehyde, respectively. It is apparent that much smaller potentials of 0.13 and 0.36 V vs RHE are required to produce 100 and 500 mA/cm², respectively, than those required for OER on Ni/NF. Nearly unity Faradaic efficiencies were obtained for both hydrogen and formate production when paraformaldehyde was employed as the feedstock and Cu₃Ag₇/CF as the anode electrocatalyst at different applied potentials from 0.1 to 0.4 V vs RHE (FIG. 6b). When paraformaldehyde was used as the oxidation substrate, the yields of methanol and formate from the competing Cannizzaro reaction were much lower than those directly using HCHO solutions, suggesting another advantage of using paraformaldehyde as the feedstock for the dual HER strategy. The long-term stability test of electrolysis using PFA was also carried out using a flow cell consisting of AEM and Ni₃N/Ni/NF(−)∥Cu₃Ag₇/CF(+) electrode couple in a zero-gap configuration. The electrolysis was performed at 100 mA cm⁻² with 1.0 M KOH as the catholyte and 1.0 M KOH plus 10.0 g/L PFA as the anolyte, both of which were fed into the cell at a flow rate of 50 mL min-1. The electrolyte was refreshed every 24 h. The dual hydrogen production strategy (HER/FOR) using the Ni₃N/Ni/NF(−)∥Cu₃Ag₇/CF(+) electrode couple can maintain a low voltage input (0.4-0.6 V without iR correction) to deliver 100 mA cm⁻² over 260 h, indicating the great robustness of the electrocatalysts for dual hydrogen production.

From an energy efficiency perspective, dual hydrogen production system surpasses those conventional water splitting systems to a substantial extent. For instance, FIG. 6c compares the electricity consumption between the dual hydrogen production strategy (HER/FOR) using the Ni₃N/Ni/NF(−)∥Cu₃Ag₇/CF(+) electrode couple and traditional water electrolysis (HER/OER) using the Ni₃N/Ni/NF(−)∥Ni/NF(+) electrode couple. To produce hydrogen at a current density of 100 mA/cm², the dual hydrogen production system only requires 0.30 kWh electricity per m³ hydrogen whereas conventional water splitting demands 4.10 kWh. Even at an industrially applicable current density of 500 mA/cm², the electricity consumption of the dual hydrogen production system is still as small as 0.70 kWh per m³ hydrogen, much slower than that of water electrolysis (4.70 kWh per m³ hydrogen).

In summary, the present disclosure provides a new bimetallic electrocatalyst Cu₃Ag₇ for efficient hydrogen production at the anode of an electrolyzer which integrates the partial oxidation of formaldehyde with water reduction to realize dual HER with an apparent 200% Faradaic efficiency. DFT computation reveals a key adsorption conformation of the H₂C(OH)O* intermediate on Cu₃Ag₇ that is highly conducive to C—H cleavage. In addition to formaldehyde solution, solid-phase paraformaldehyde can be equally employed as a reactant to realize similar performance, paving the way for practical application on a large scale.

### EXAMPLES

Chemicals. All chemicals were used as received without any further purification. Copper (II) nitrate hydrate, silver nitrate, copper (II) sulfate pentahydrate, silver sulfate, potassium hydroxide (>85%), formaldehyde solution (37 wt. % in H2O), paraformaldehyde (PFA), formic acid (>99%), methanol (>99.9%), tert-butanol (anhydrous), hydrochloric acid (ACS reagent, 37%), sodium citrate were purchased from Sigma Aldrich. Ammonium chloride and nickel (II) chloride hexahydrate were purchased from Alfa Aesar. Copper foam and nickel foam with purity >99.99% were purchased from MTI. Deionized water (18 MΩ·cm) from a Barnstead E-Pure system was used in all experiments.

Synthesis. Synthesis of Cu, Ag, and CuAg catalysts on rotating disk electrode: The catalysts were synthesized through an electrodeposition method by using a three-electrode system on a VMP-3 potentiostat (Biologic Science Instrument). A rotating disk electrode with glassy carbon (RDE, 0.196 cm-2, Pine Research Instrumentation) was used as the working electrode with a leakless Ag/AgCl (eDAQ) reference electrode and a Pt mesh counter electrode. −0.2 V vs. Ag/AgCl was applied to the RDE working electrode for the reduction of Cu and Ag ions in the electrolyte. The electrodeposition ended when a charge of 60 mC had been passed. Cu modified on RDE (Cu/RDE) and Ag modified on RDE (Ag/RDE) were electrodeposited at −0.2 V vs Ag/AgCl from an aqueous electrolyte containing specific amounts of Cu(NO3)2 (20.0 mM, 30 mL) and AgNO₃ (20.0 mM, 30 mL), respectively. For comparison, the CuxAg10−x/RDE (x=1, 3, 5, 7, and 9) were prepared under the same conditions from precursor electrolytes (20.0 mM, 30.0 mL) containing AgNO₃ and Cu(NO₃)₂ solutions with different concentration ratios (from 1/9 to 9/1).

Synthesis of Cu₃Ag₇ catalysts on Cu foam (Cu₃Ag₇/CF): To avoid the introduction of other metal composites, copper foam (0.5 cm×0.5 cm) was used as the catalyst support and current collector. The copper foam was sequentially washed with 1.0 M HCl, ethanol, and deionized water (each for 10 min). Cu₃Ag₇/CF was synthesized through electrodeposition on a Gamry Interface 1000 electrochemical workstation with a three-electrode configuration, using a carbon rod and a leakless Ag/AgCl (eDAQ) electrode as the counter electrode and reference electrode, respectively. Cu₃Ag₇/CF was electrodeposited at a constant current of −3.0 A cm-2 for 30 s from an aqueous electrolyte (30 mL) containing specific amounts of Ag₂SO₄ (14.0 mM) and CuSO₄ (6.0 mM) in 1.5 M H₂SO₄ under Ar without stirring. In addition, 0.1 M sodium citrate was added into the precursor as a complexing agent. To avoid the interference of the background signal from copper foam in the XRD tests, Cu-modified, Ag-modified and Cu₃Ag₇-modified carbon paper electrodes (Cu/CP, Ag/CP, and Cu₃Ag₇/CP) samples were prepared following the same preparation conditions. The only difference is that copper foam was replaced by carbon paper.

Synthesis of Ni/NF and Ni₃N/Ni/NF: Based on prior work, the Ni₃N/Ni/NF electrode was synthesized from the electrodeposition of Ni particles on a nickel foam (NF) followed by thermal nitridation. (Song, et al. Nat. Commun. 9, 4531 (2018)) A piece of clean nickel foam (0.5 cm□0.5 cm) was used as the working electrode. A carbon rod was used as the counter electrode. The Ni/NF was synthesized through electrodeposition at a constant current density of −1.0 A cm-2 for 500 s in a two-electrode cell containing NiCl₂ (0.1 M) and NH₄Cl (2.0 M) under Ar without stirring. The Ni₃N/Ni/NF was obtained from the thermal annealing of Ni/NF under an NH₃ flow at 300° C. for 6 hours with a ramping rate of 10° C. min-1.

Physical characterization. The morphology features of samples were assessed by using scanning electron microscopy (FEI XL30, 15 kV), as well as transmission electron microscopy (TEM), selective area electron diffraction (SAED, 40 μm aperture), and scanning transmission electron microscopy (STEM) with a FEI Tecnai Osiris (200 kV). Samples for TEM were prepared by suspending dry Cu₃Ag₇/CF electrocatalyst on carbon-coated 200-mesh copper TEM grids (Ted Pella 01894-F). STEM-energy-dispersive X-ray spectroscopy (EDX) maps were collected using Bruker Esprit 1.9 software and averaged over 8 scans. X-ray diffraction (XRD) patterns were collected on a Philips X'Pert Pro PW3040/00 (PAN analytical) instrument. The scan range was set from 20° to 90° (in 20) with a Cu-tube operated at 45 kV and 40 mA. The evolved H₂ through the electrolysis process was quantified by gas chromatography (GC, SRI 8610C) equipped with a Molecular Sieve 13 packed column, a HayesSep D packed column, and a thermal conductivity detector, and Ar was used as the carrier gas. The Cu and Ag quantities of the sample were analyzed via inductively coupled plasma mass spectrometry (ICP-MS, Agilent 7700 series) in 2% nitric acid. 1H NMR spectra were recorded in the designated solvents on a Bruker AV 400 MHz spectrometer. UV-vis absorption spectra were collected on an Agilent 8454 UV-Vis Spectrophotometer.

Electrochemical measurements. All catalysts on RDE were tested on an electrochemical workstation (VMP-3 potentiostat, Biologic Science Instrument) with a modulated speed rotator (PINE Research Instrumentation) at room temperature in a standard three-electrode configuration. An RDE (0.196 cm²) was utilized as the working electrode, while a Pt mesh and an Hg/HgO (1.0 M KOH) electrode were used as the counter electrode and reference electrode, respectively. All potentials herein were referenced to the reversible hydrogen electrode (RHE) through calibration via Pt foil as the working electrode in the H₂-saturated electrolyte. All potentials measured in 1.0 M KOH were converted to the value versus RHE according to the equation: ERHE=EHg/HgO+0.924 V. Commercial formaldehyde (37 wt %) solution was directly used as the oxidation substrate. The Cu/RDE, Ag/RDE, and CuxAg₁₀₋ₓ/RDE were treated using cyclic voltammetry (CV) from 0 VRHE to 0.3 VRHE at 50 mV s-1 for 20 cycles to obtain metallic Cu or Ag in 1.0 M KOH under Ar prior to the HCHO electrooxidation (FOR) test (Supplementary FIG. 20). All CVs of FOR were performed in electrolyte under Ar at a scan rate of 10 mV s-1 and a rotation rate of 1500 rpm without iR correction in a standard three-electrode configuration. For investigating the effect of [OH—], 1.0 M anion concentration anolyte consisted of NaOH and NaClO₄ with different concentrations to avoid the interference of conductivity change. All potentials herein were referenced to the reversible hydrogen electrode (RHE) through calibration using Pt foil as the working electrode in H₂-saturated electrolytes with different OH— concentrations. The electrochemical double-layer capacitance (Cdl) measurements were performed using cyclic voltammetry, which were collected in a non-Faradaic region with various scan rates ranging from 20 to 200 mV s-1 at potentials between 0.07 V and 0.17 V vs RHE in 1.0 M KOH under Ar. For paraformaldehyde (PFA) oxidation on RDE, all experimental procedures were the same as FOR.

The measurements of FOR on Cu₃Ag₇/CF, HER on Ni₃Ni/Ni/NF, and OER on Ni/NF were conducted on the VMP-3 potentiostat in an H-cell with an anion exchange membrane (Fumasep FAA-3-50), using a Pt mesh as the counter electrode and a Hg/HgO (1.0 M KOH) as the reference electrode, respectively. Cu₃Ag₇/CF was treated using cyclic voltammetry from 0 VRHE to 0.3 VRHE at 50 mV s-1 for 20 cycles to obtain metallic Cu or Ag in 1.0 M KOH under Ar prior to the HCHO electrooxidation test. All CVs (FOR, HER and OER) in a three-electrode configuration were collected at a scan rate of 10 mV s-1 without iR correction. The two-electrode electrolysis was performed on an electrochemical workstation in H-cell with an anion exchange membrane. For conventional water electrolysis, the Ni/NF and Ni₃Ni/Ni/NF were employed as the anode and cathode in 1.0 M KOH, respectively. For a two-electrode electrolyzer of FOR/HER, Cu₃Ag₇/CF was the anode and Ni₃N/Ni/NF was the cathode, in which 1.0 M KOH and 0.6 M HCHO was used as the anolyte and 1.0 M KOH as the catholyte. The uncompensated resistance (Ru) of 1.0 M KOH in the absence or presence of HCHO was determined by the Current Interrupt (CI) method of a VMP-3 potentiostat and the value of Ru was measured as 15±0.2Ω. All CVs in a two-electrode configuration were collected under Ar at a scan rate of 10 mV s-1 with iR compensation by the automatic CI method with a value of 90%×Ru through the EC-lab software. For the gas products analysis from the anode chamber, different cell voltages (0.2 V-0.8 V) were applied for chronoamperometry where Cu₃Ag₇/CF was employed as the anode and Ni₃N/Ni/NF as the cathode in a two-electrode configuration. The Faradaic efficiency analysis of H₂ and formate production in cathode and anode chambers was performed from five consecutive 1 h controlled-current electrolysis (150 mA) using the Cu₃Ag₇/CF and Ni₃N/Ni/NF couple but fresh electrolyte for each cycle. The chronopotentiometry test was performed by five consecutive controlled-current electrolysis conducted at 100 and 500 mA/cm² in a fresh anolyte (1.0 M KOH and 0.6 M HCHO) of each cycle using the Ni₃N/Ni/NF(−)∥Cu₃Ag₇/CF(+) electrode couple. The chronoamperometry measurement was carried out at a cell voltage of 0.6 V with the periodic replenishment of fresh HCHO back to its original 0.1 M concentration. For the electrocatalytic paraformaldehyde oxidation on Cu₃Ag₇/CF, all experimental procedures were the same as FOR. The long-term stability test was carried out in a home-made flow cell with serpentine flow channels (1 cm×1 cm) using Cu₃Ag₇/CF as the anode and Ni₃N/Ni/NF as the cathode on a Biologic VMP-3 potentiostat without iR-compensation. The catholyte (1.0 M KOH) and anolyte (1.0 M KOH and 10.0 g/L PFA) were fed into the cell at a flow rate of 50 mL min-1 by a peristaltic pump (Peri-Star Pro Peristaltic Pump, World Precision Instruments) and recycled. The electrolyte was refreshed every 24 h. An anion exchange membrane (Fumasep FAA-3-50) was used to separate the anolyte and catholyte.

Product analysis. The evolved H₂ in both anode chamber and cathode chamber of a two-electrode electrolyzer of FOR/HER was analyzed by gas chromatography (GC, SRI 8610C) equipped with a Molecular Sieve 13 packed column, a HayesSep D packed column, and a thermal conductivity detector. The oven is kept at 80° C. using Ar as carrier gas. The quantity of H₂ production was determined via a water displacement method.

The concentration of formaldehyde during electrolysis was quantified via UV-vis absorption measurement following the Hantzsch reaction. Ammonium acetate (15.4 g) in water (50 mL), glacial acetic acid (0.3 mL) and acetyl acetone (0.2 mL) were mixed to form a solution under stirring, which was further diluted with water (49.5 mL). To measure the concentration of formaldehyde, 20.0 μL of anolyte was acidified by 20 μL 2.0 M HCl and then diluted 2500 times prior to and post electrolysis. Subsequently, 2.0 mL of the diluted solution was mixed with the acetyl acetone solution (2.0 mL), which was further heated to 60° C. for 10 min. After cooling for 10 min, the absorbance of the sample solution at 413 nm was measured. The quantification of HCHO was obtained from the calibration curves by applying standard solutions with known concentrations of commercially purchased pure HCHO.

The identification and quantification of formic acid and methanol were determined from the 1H NMR using calibration curves with t-butanol (10.0 mM) as an internal standard. 100 μL electrolyte from anolyte and catholyte prior to and post electrolysis was acidified by 20 μL HCl (37%) and then added into 500 μL D₂O. ¹H NMR was recorded using a water suppression method.

The Faradaic efficiency was calculated on the basis of the following equation:

$$FE ( \% ) = ( nF \times N / Qtotal charge passed ) \times 100$$

where n is the number of electrons transferred for each product molecule, F is Faraday's constant (96485 C mol-1), N is the mole number of products and Q is the total passed charge. The carbon balance (%) of the electrooxidation process was calculated using the following equation:

$$carbon balance ( \% ) = \frac{mol of organic products}{mol of formaldehyde consumed} \times 100$$

Theoretical computation. Density functional theory (DFT) calculations were performed by using Vienna Ab initio Simulation Package (VASP). The Perdew-Burke-Ernzerhof (PBE) functional within the generalized gradient approximation (GGA) was used for electron exchange-correlation. Projector augmented wave (PAW) potential was used to treat the nuclei-electron interaction. An energy cutoff of 400 eV was chosen for plane wave basis sets. The atomic positions were relaxed until the force on each atom was less than 0.05 eV/Å. Electronic energies were converged within 10-4 eV. Transition states were searched using the Climbing Image Nudged Elastic Band approach. Frequency analysis was carried out to ensure that there was only a single imaginary frequency for the transition state.

The bulk model of Cu₃Ag₇ was built based on the bulk model of Ag. Starting with a 2×2×2 supercell of bulk Ag with 16 Ag atoms, two Ag atoms were replaced with Cu and obtained four different geometries for Cu₂Ag₁₄. After optimization, the lowest energy structure was used as a starting structure to generate six different geometries for Cu₃Ag₁₃ from replacing one Ag in Cu₂Ag₁₄ with Cu. Repeating the optimization and the single-atom substitution of the lowest-energy structure, seven geometries of Cu₄Ag₁₂ and two geometries of Cu₅Ag₁₁ were tested and compared. In total, over 20 bulk geometries were examined to a stable structure for Cu₃Ag₁₁ (Cu/Ag=0.45) which was used to approximate the bulk Cu₃Ag₇ (Cu/Ag=0.43) composition. A slab with five layers in a (3×3) lateral supercell was built for Cu₃Ag₇, Ag, and Cu (111) surfaces and sampled by 2×2×1 k-point mesh. The bottom two layers were fixed, and the other atoms were all relaxed during the structural optimization. The vacuum layer was set to be 15 Å.

Various modifications of the present disclosure, in addition to those shown and described herein, will be apparent to those skilled in the art of the above description. Such modifications are also intended to fall within the scope of the appended claims.

It is appreciated that all reagents are obtainable by sources known in the art unless otherwise specified.

It is also to be understood that this disclosure is not limited to the specific aspects and methods described herein, as specific components and/or conditions may, of course, vary. Furthermore, the terminology used herein is used only for the purpose of describing particular aspects of the present disclosure and is not intended to be limiting in any way. It will be also understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein. Similarly, as used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Unless otherwise indicated, all numbers expressing quantities of ingredients, properties such as reaction conditions, and so forth used in the specification and claims are to be understood as being modified in all instances by the term “about.” Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments #1%, in some embodiments ±0.5%, and in some embodiments ±0.1% from the specified amount, as such variations are appropriate to perform the disclosed method.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Reference is made in detail to exemplary compositions, aspects and methods of the present disclosure, which constitute the best modes of practicing the disclosure presently known to the inventors. The drawings are not necessarily to scale. However, it is to be understood that the disclosed aspects are merely exemplary of the disclosure that may be embodied in various and alternative forms. Therefore, specific details disclosed herein are not to be interpreted as limiting, but merely as a representative basis for any aspect of the disclosure and/or as a representative basis for teaching one skilled in the art to variously employ the present disclosure.

Patents, publications, and applications mentioned in the specification are indicative of the levels of those skilled in the art to which the disclosure pertains. These patents, publications, and applications are incorporated herein by reference to the same extent as if each individual patent, publication, or application was specifically and individually incorporated herein by reference.

The foregoing description is illustrative of particular embodiments of the disclosure, but is not meant to be a limitation upon the practice thereof. The following claims, including all equivalents thereof, are intended to define the scope of the disclosure.

1. An electrocatalytic system comprising an electrolyte solution, a cathode, and an anode, wherein the anode comprises a bimetallic alloy of copper and silver.

2. The electrocatalytic system of claim 1, wherein the bimetallic alloy is Cu₃Ag₇.

3. The electrocatalytic system of claim 1, wherein the bimetallic alloy is electrodeposited on a substrate of copper film (CF) or carbon paper (CP).

4. The electrocatalytic system of claim 1, wherein the electrolyte solution comprises a basic salt.

5. The electrocatalytic system of claim 4, wherein the basic salt is potassium hydroxide.

6. The electrocatalytic system of claim 5, wherein the potassium hydroxide is of a concentration of about 1 M.

7. The electrocatalytic system of claim 1, further comprising a separator, wherein the electrolyte is comprised of a catholyte and an anolyte with the separator placed therebetween.

8. The electrocatalytic system of claim 7, wherein the anolyte comprises an aldehyde.

9. The electrocatalytic system of claim 8, wherein the aldehyde is an aromatic aldehyde or an aliphatic aldehyde.

10. (canceled)

11. The electrocatalytic system of claim 8, wherein the aldehyde is formaldehyde or paraformaldehyde.

12. The electrocatalytic system of claim 11, wherein the aldehyde is formaldehyde.

13. The electrocatalytic system of claim 12, wherein formaldehyde is has a concentration of 0.6 M or less.

14. The electrocatalytic system of claim 11, wherein the aldehyde is paraformaldehyde.

15. The electrocatalytic system of claim 14, wherein paraformaldehyde has a concentration of 10 g/L or less.

16. A method for producing hydrogen gas at an anode and a cathode, comprising
providing the electrocatalytic system as set forth in claim 1;
applying a circulating voltage to the electrocatalytic system through the anode and the cathode; and,
collecting hydrogen gas at both the anode and the cathode.

17. A method for reducing aldehyde pollution comprising providing an aldehyde polluted solution to the electrocatalytic system of claim 1.

18. A method for producing hydrogen gas from an aldehyde, comprising:
providing an electrocatalytic system, the electrocatalytic system comprising a cathode, an anode, and an electrolyte solution, wherein the anode comprises Cu₃Ag₇ and the electrolyte solution comprises an anolyte, a catholyte and a separator, wherein the anolyte and the catholyte are both of a basic pH and wherein the anolyte comprises an aldehyde;
providing by electric current two electrons to the cathode to produce hydrogen gas according to the following reaction: 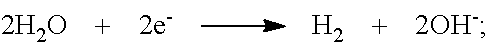
and,
transporting the 2OH⁻ passively across the separator to the anode to produce hydrogen gas according to the following reaction: 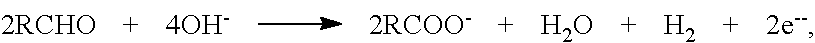
wherein R is any aliphatic and/or aromatic aldehyde; and,
collecting hydrogen gas at the anode and the cathode.

19. The method of claim 18, wherein the catholyte comprises about 1.0 M KOH.

20. The method of claim 18, wherein the anolyte further comprises about 1.0 M KOH.

21. The method of claim 18, wherein the aldehyde comprises formaldehyde and/or paraformaldehyde.
